(19) United States
(12) Patent Application Publication
(10) Pub. No.: US 2004/0218067 A1
(43) Pub. Date: Nov. 4, 2004

(54) Digital multi-media input device with continuously store function and method for forming the same

(76) Inventors: Huang-Tsun Chen, Datung Chiu (TW); Kuo-Chuan Chiang, Jung-Li City (TW)

Correspondence Address: Thomas T Moga, Dickinson Wright PLLC, 1904 L Street NW Suite 800, Washington, DC, 20036, US

(21) Appl. No.: 09/943,018

(22) Filed: Aug. 30, 2001

(51) Int. Cl. H04N 5/76

(52) U.S. Cl. 348/231.99

(57) ABSTRACT

Digital multi-media input device with continuously store function and method for forming the same. A buffering means is used to assist the conventional external storing means in the storage of multi-media data which is the product of a multi-media detecting means. Whenever the quota of the external storing means is full, the external storing means being exchanged, or the external storing means is failed, all multi-media data which being produced by the multi-media detecting means are transmitted only into the buffering means. Besides, after the external storing means is available again to store any recently inputted multi-media data, all multi-media data in the buffering means, which are stored while the external storing means being unavailable, are transmitted into the external storing means.

### BACKGROUND OF THE INVENTION

1. Field of the Invention

The invention relates to the field of multi-media input device for continuously information storage, and is most closely related to the field of preventing multi-media data loss induced by imperfect storage.

2. Description of the Prior Art

Current multi-media input devices, such as digital camera, usually use external memory to store data. As FIG. 1A shows, during the operation of digital multi-media input device, numerous multi-media data, such as image data, acquired by multi-media detecting means 11 and then processed by multi-media processing means 12. Next, all processed multi-media data are stored in external memory, such as external memory. Then, while operation of digital multi-media input device is finished, external memory 13 or stored multi-media data would be transferred into computer to further process these acquired data. Certainly, during the operation of digital multi-media input device, it is acceptable to replace a full external memory 132 by a non-full external memory 131. Note that the words “non-full” used herein and all the specification means that a non-full memory is available to store recently inputted data without losing any data which has been stored in the non-full memory. A non-full memory could be a totally empty memory or a partially empty memory.

FIG. 1B shows four stages of previous acceptable operation: use non-full external memory 131 to store multi-media data, external memory 131 is full by inputted multi-media data and becomes full external memory 132, remove full external memory 132, and use another non-full external memory 133 to store multi-media data. Clearly, from the original external memory is full to a new partially full external memory is used to store, all multi-media data which being transmitted from the multi-media processing means would be lost for no place to store them. Surely, recently transmitted multi-media data still could be written into the full external memory, but recently written multi-media data always replace stored multi-media data. In other words, always some multi-media data are lost, either recently transmitter multi-media data or stored multi-media data.

For examples, while the digital multi-media input device is a digital camera and the digital camera is designed to continuously photograph, exchange process of external memory 13 would induce lost of photographed images. Similarly, while the digital multi-media input device is a digital recorder, exchange process of external memory 13 would induce lost of record sound.

Indisputably, conventional digital multi-media input device which only uses external memory could not ensure all inputted multi-media data are stored. Thus, it is desired to develop new technology to overcome the defect that multi-media data are lost during exchange of external memory.

### SUMMARY OF THE INVENTION

One main object of this invention is to provide a digital multi-media input device with continuously store function and method to achieve this function.

Another main object of this invention is to provide a digital multi-media input device which is simple in hardware structure so that the manufacturing cost thereof is low, and also is simple is software so that the operation thereof is easy.

One preferred embodiment of this invention is a digital multi-media input device with continuous store function, at least has multi-media detecting means, multi-media processing means, external storing means, buffering means, and storage controlling means. Multi-media detecting means continuously detects numerous objects to continuously acquire numerous multi-media data. And, multi-media processing means continuously process these multi-media data while these multi-media data being transmitted from multi-media detecting means. Both external storing means and buffering means store these multi-media data after these multi-media data are processed by the multi-media processing means. Finally, storage controlling means control the operation of both external storing means and buffering means, so let these multi-media data be transmitted into both external storing means and buffering means while the external storing means being available to store recently transmitted multi-media data, and to let these multi-media data only be transmitted into buffering means while the external storing means being unavailable to store recently transmitted multi-media data.

Another preferred embodiment of this invention is a method for providing a continuous store function for a digital multi-media input device. Initially, continuously detect numerous objects by a multi-media detecting means to continuously acquire numerous multi-media data. Then, continuously process these multi-media data by a multi-media processing means, wherein these multi-media data are continuously transmitted from the multi-media detecting means to the multi-media processing means. And then, store processed multi-media data in both an external storing means and a buffering means, wherein the operation of both the external storing means and the buffering means are controlled by a storage controlling means. Moreover, these multi-media data only are transmitted in the buffering means while the external storing means being unavailable to storage any multi-media data which are recently transmitted from the multi-media processing means.

To compare conventional digital multi-media input device and corresponding operation process, significantly, one important characteristic of this invention is the application of buffering means. Because multi-media data could be stored in buffering means while external storing means being exchanged, it is possible to avoid any loss of multi-media data.

### BRIEF DESCRIPTION OF THE DRAWINGS

A more complete appreciation and many of the attendant advantages will be readily obtained as the same becomes better understood by reference to the following detailed description when considered in connection with the accompanying drawings.

FIG. 1A to FIG. 1B shows basic structure of conventional digital multi-media input device and four operating stages of conventional digital multi-media input device separately;

FIG. 2A to FIG. 2B shows basic structure of conventional digital multi-media input device and four operating stages of conventional digital multi-media input device separately; and

FIG. 3A through FIG. 3C shows some possible flow chart of the method present by this invention.

### DESCRIPTION OF THE PREFERRED EMBODIMENT

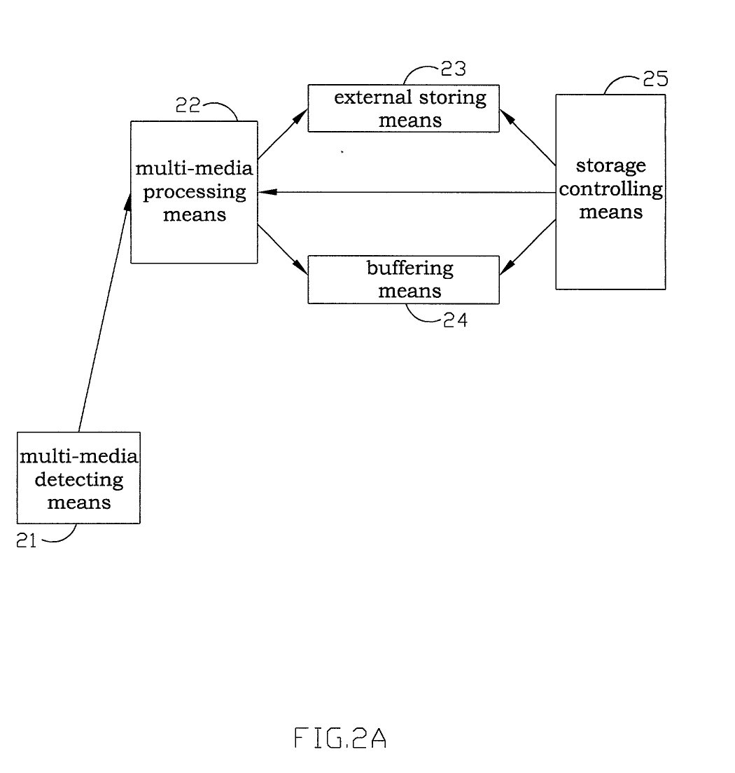

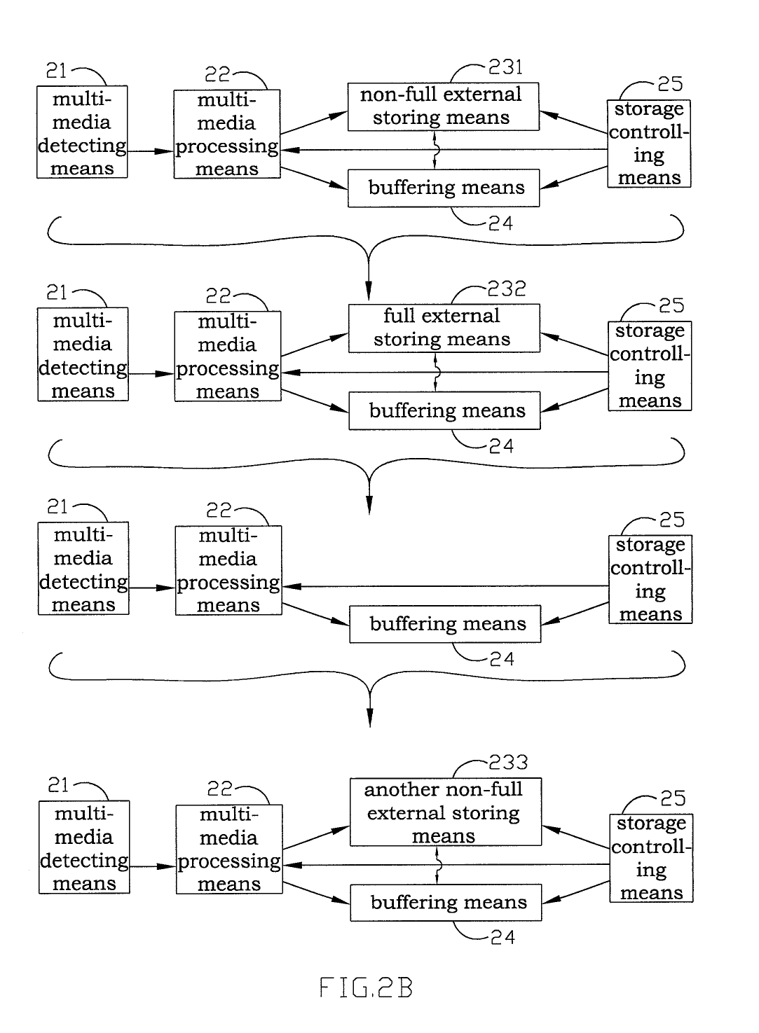

FIG. 2A shows the basic structure of the digital multi-media input device which has continuously storing function and is present by this invention, especially the basic structure of the part that is directly related to process of multi-media data and storage of multi-media data. As FIG. 2A shows, the present digital multi-media input device at least has multi-media detecting means 21, multi-media processing means 22, external storing means 23, buffering means 24, and storage controlling means 25.

Multi-media detecting means 21 continuously detects numerous objects to continuously acquire numerous multi-media data. Multi-media processing means 22 continuously process these multi-media data while these multi-media data being transmitted from multi-media detecting means 21. Both external storing means 23 and buffering means 23 store these multi-media data after these multi-media data are processed by multi-media processing means 22. Finally, storage controlling means 25 control the operation of both external storing means 23 and buffering means 24, so let these multi-media data be transmitted into both external storing means 23 and buffering means 24 while the external storing means 23 being available to store recently transmitted multi-media data, and to let these multi-media data only be transmitted into buffering means 23 while the external storing means being unavailable to store recently transmitted multi-media data.

Note that the term that external storing means 23 is unavailable to store recently transmitted multi-media data means following two cases: one case is that external storing means 23 could store any new multi-media data without losing any stored multi-media data, another case is that external storing means 23 could not receive any new multi-media data. Further, possible reasons at least include the quota of external storing means 23 is full, external storing means 23 being exchanged, and external storing means 23 is failed.

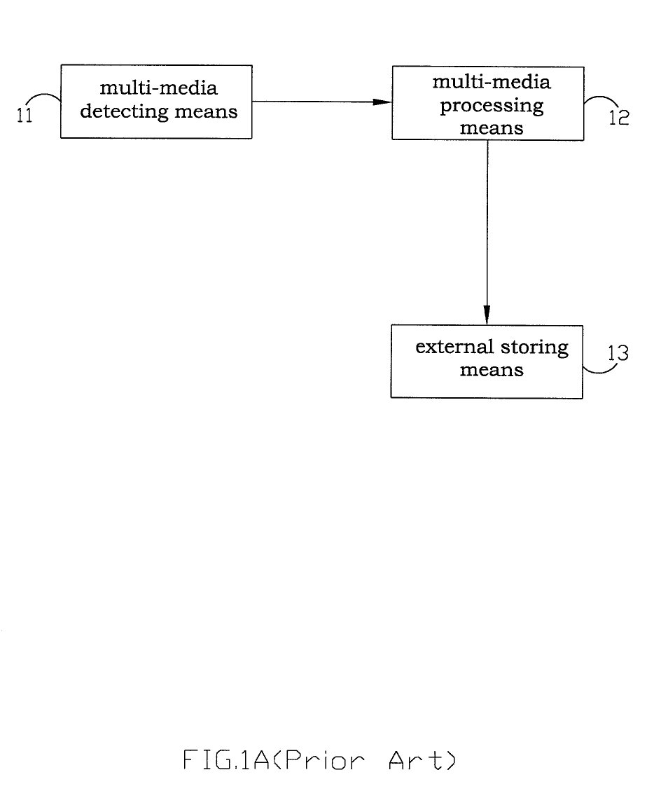

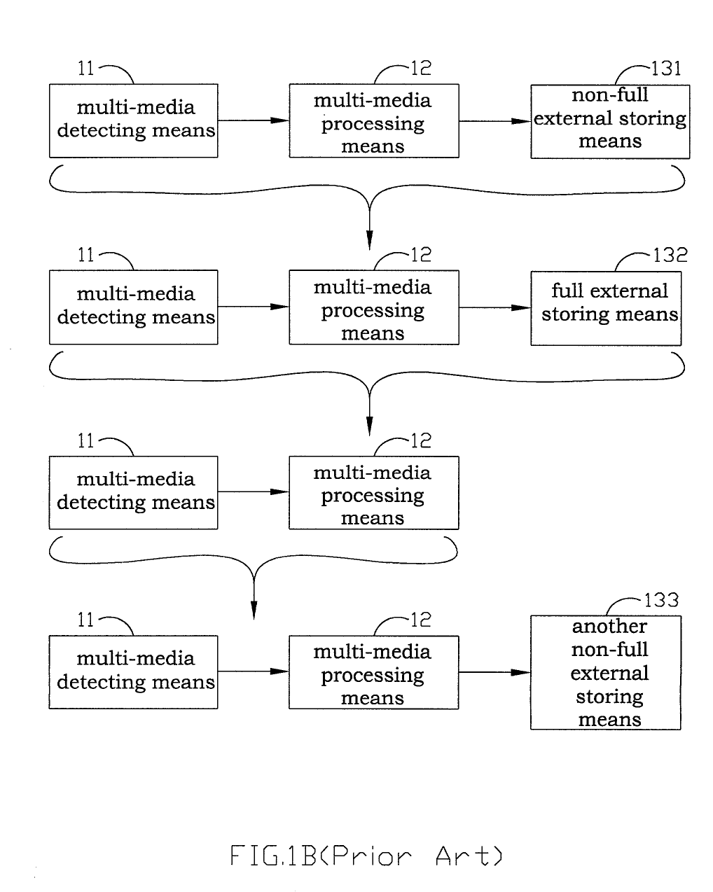

Significantly, by comparing FIG. 2A with FIG. 1A, one main difference between this invention and conventional technology is that both buffering means 24 and storage controlling means 25 are used to assist storage of media data.

Refers to the operation shown in FIG. 2B, and notes that storage controlling means 25 could switch the flow of multi-media data between external storing means 23 and buffering means 24. Whenever the originally partially-empty external storing means 231 is totally full by transmitted multi-media data and become a full external storing means 232, recently transmitted multi-media data would be totally stored in buffering means 24 but not stored in the full external storing means 232. Moreover, after the full external storing means 232 is replaced by a non-full external storing means 233, recently transmitted multi-media data are transmitted in the non-full external storing means 233, and all multi-media data stored in buffering means 24 during the period that no non-full external means 231/233 is available also are transmitted into the non-full external storing means 233. Therefore, indisputably, this invention could ensure all multi-media processed by multi-media processing means 22 would not be lost, even external storing means 23 could not continuously stored recently transmitted multi-media data for external storing means 23 being exchanged or other reasons.

Of course, while the negligent of user let buffering means 24 also are totally full so that no recently transmitted multi-media data can be stored, this invention also can not ensure all processed multi-media data are correctly stored. However, the negligent of user is unavoidable for any technology and any device, and it is not defects of this invention. In fact, the invention does not modify the operation of user, and then the invention would not induce any operation difficulty that conventional digital multi-media input device never meet, except the maintenance of buffering means 24.

In addition, the digital multi-media input device could be a digital camera or a digital recorder. Multi-media detecting means 21 could be charger coupled device (CCD) or optical lens. Multi-media processing means 22 could be microprocessor or application specific integrated circuits. External storing means 23 could be CompactFlash, SmartMedia, MultiMedia Card, Secure Digital, or MemoryStick. And buffering means 24 could be flash or dynamic random access memory.

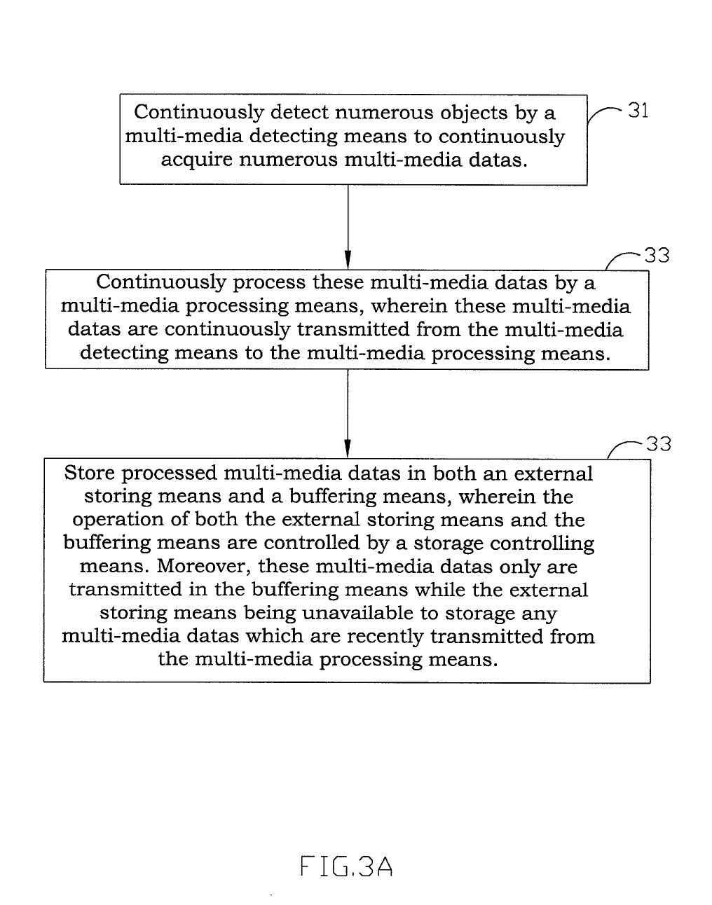

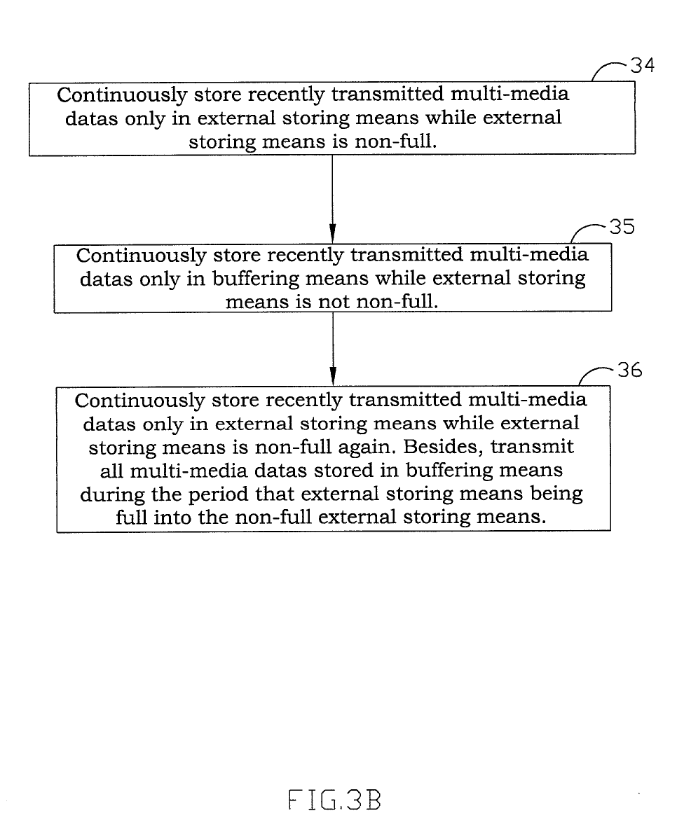

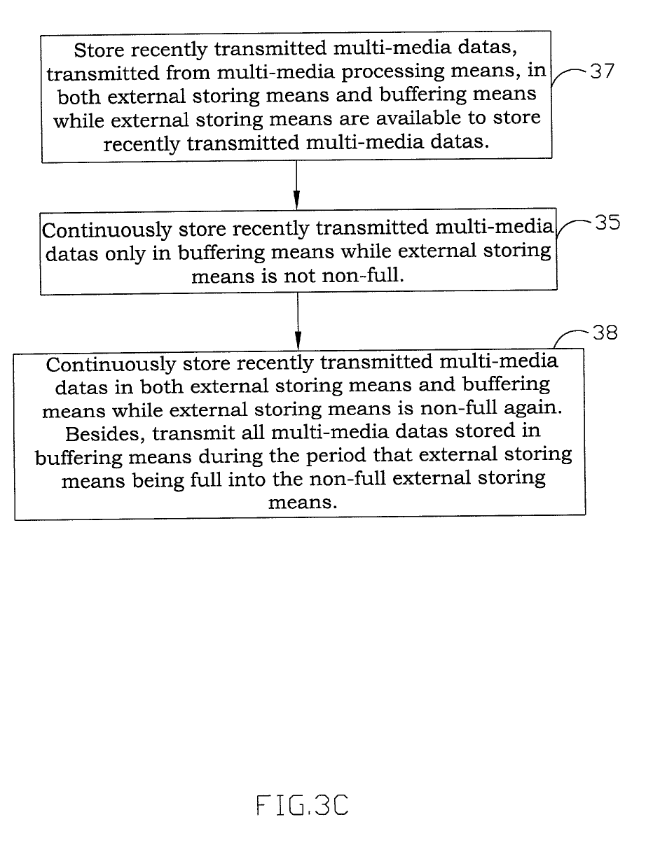

FIG. 3A shows the basic flow-chart of a method present by the invention to provide a continuous store function for a digital multi-media input device.

As forming multi-media data block 31 shows, continuously detect numerous objects by a multi-media detecting means to continuously acquire numerous multi-media data.

As processing multi-media data block 32 shows, continuously process these multi-media data by a multi-media processing means, wherein these multi-media data are continuously transmitted from the multi-media detecting means to the multi-media processing means.

As storing multi-media data block 33 shows, store processed multi-media data in both an external storing means and a buffering means, wherein the operation of both the external storing means and the buffering means are controlled by a storage controlling means. Moreover, these multi-media data only are transmitted in the buffering means while the external storing means being unavailable to storage any multi-media data which are recently transmitted from the multi-media processing means.

Surely, storing multi-media data block 33 only shows the essential concepts, in accomplish with different switching mode between external storing means and buffering means, this method at least has following modification.

As FIG. 3B shows, after both forming multi-media data block 31 and processing multi-media data block 32 are finished, perform single storage block 34, exchange block 35, and single re-storage block 36 in sequence.

Single storage block 34 indicates the step of continuously storing recently transmitted multi-media data only in external storing means while external storing means is non-full.

Exchange block 35 indicates the step of continuously storing recently transmitted multi-media data only in buffering means while external storing means is not non-full.

Single re-store block 36 indicates the step of continuously storing recently transmitted multi-media data only in external storing means while external storing means is non-full again. Besides, single re-store block 36 also indicates the step of transmitting all multi-media data stored in buffering means during the period that external storing means being full into the non-full external storing means.

As FIG. 3C shows, after both forming multi-media data block 31 and processing multi-media data block 32 are finished, perform double storage block 37, exchange block 35, and double re-storage block 38 in sequence.

Double storage block 37 indicates the step of storing recently transmitted multi-media data, transmitted from multi-media processing means, in both external storing means and buffering means while external storing means are available to store recently transmitted multi-media data. Certainly, it is better to let quota of buffering means is not full or nearly full, to ensure function of buffering means is correct. Moreover, one main object of storing multi-media data in buffering means is to avoid any loss during the period that flow of multi-media data is changed from external storing means into buffering means, which may be unavoidable for the flow shown in FIG. 3B.

Double re-storage block 38 indicate the steps of continuously storing recently transmitted multi-media data in both external storing means and buffering means while external storing means is non-full again. Besides, double re-storage block 38 also indicate the steps of transmitting all multi-media data stored in buffering means during the period that external storing means being full into the non-full external storing means.

Furthermore, the flow shown in FIG. 3C at least has following two variations.

One variation. While the external storing means being available to store any recently inputted multi-media data, these multi-media data which transmitted from the multi-media means are synchronously stored into both the external storing means and the buffering means. Moreover, after the quota of partial multi-media data which are stored in the buffering means exceeds a predetermined quota, partial multi-media data which are stored in the buffering means are removed to let recently transmitted partial multi-media data from the multi-media processing means can be stored in the buffering means in accordance with the step of first-in and first-out.

Another variation. While the external storing means being available to store these multi-media data, multi-media data which are transmitted from the multi-media processing means are directly transmitted into the buffering means and indirectly transmitted into the buffering means in sequence. Moreover, any multi-media data which are stored in the buffering means and exceeds a predetermined quota would be removed into the external storing means, in accordance with the step of first-in and first-out, to let recently transmitted partial multi-media data from the multi-media processing means could be stored in the buffering means.

From the foregoing it will be appreciated that, although specific embodiments of the invention have been described herein for the purpose of illustration, various modifications may be made without deviating from the spirit and scope of the invention. Accordingly, the invention is not limited except as by the appended claims.

What is claimed is:

1. A method for providing a continuous store function for a digital multi-media input device, comprising:
continuously detecting a plurality of objects to let a multi-media detecting means continuously acquire a plurality of multi-media data;
continuously processing said multi-media data by a multi-media processing means, wherein said multi-media data are continuously transmitted from said multi-media detecting means to said multi-media processing means; and
storing processed said multi-media data in an external storing means and a buffering means, wherein the operation of both said external storing means and said buffering means are controlled by a storage controlling means, said multi-media data only are transmitted in said buffering means while said external storing means being unavailable to storage any said multi-media data which are transmitted from said multi-media processing means.

2. The method of claim 1, said digital multi-media input device is a digital camera.

3. The method of claim 1, wherein possible reasons which let said external storing means be unavailable to storage any said multi-media data comprising the quota of said external storing means is full, said external storing means being exchanged, and said external storing means is failed.

4. The method of claim 1, further comprising:
continuously storing partial said multi-media data which transmitted from said multi-media means only into said external storing means while said external storing means being available to store any recently inputted said multi-media data;
continuously storing partial said multi-media data which transmitted from said multi-media means only into said buffering means while said external storing means being unavailable to store any recently inputted said multi-media data; and
continuously storing partial said multi-media data which transmitted from said multi-media means only into said external storing means while said external storing means being available again to store any recently inputted said multi-media data, besides, all said multi-media data which are stored in said buffering means also are totally transmitted into said external storing means.

5. The method of claim 1, further comprising:
continuously storing partial said multi-media data which transmitted from said multi-media means into both said external storing means and said buffering means while said external storing means being available to store any recently inputted said multi-media data;
continuously storing partial said multi-media data which transmitted from said multi-media means only into said buffering means while said external storing means being unavailable to store any recently inputted said multi-media data; and
continuously storing partial said multi-media data which transmitted from said multi-media means into both said external storing means and said buffering means while said external storing means being available again to store any recently inputted said multi-media data, besides, all said multi-media data which are stored in said buffering means during the period that said external storing means being unavailable to store any recently inputted said multi-media data also are totally transmitted into said external storing means.

6. The method of claim 5, partial said multi-media data which transmitted from said multi-media means are synchronously stored into both said external storing means and said buffering means while said external storing means being available to store any recently inputted said multi-media data.

7. The method of claim 6, after the quota of partial said multi-media data which are stored in said buffering means exceeds a predetermined quota, partial said multi-media data which are stored in said buffering means being removed to let recently transmitted partial said multi-media data from said multi-media processing means can be stored in said buffering means in accordance with the step of first-in and first-out.

8. The method of claim 5, while said external storing means being available to store said multi-media data, said multi-media data which are transmitted from said multi-media processing means being directly transmitted into said buffering means and indirectly transmitted into said buffering means in sequence, wherein any said multi-media data which are stored in said buffering means and exceeds a predetermined quota are removed into said external storing means, in accordance with the step of first-in and first-out, to let recently transmitted partial said multi-media data from said multi-media processing means can be stored in said buffering means.

9. A digital multi-media input device with continuous store function, comprising:
a multi-media detecting means for continuously detecting a plurality of objects to continuously acquire a plurality of multi-media data;
a multi-media processing means for continuously processing said multi-media data while said multi-media data being transmitted from said multi-media detecting means;
an external storing means for storing said multi-media data after said multi-media data are processed by said multi-media processing means;
a buffering means for storing said multi-media data after said multi-media data are processed by said multi-media processing means; and
a storage controlling means for controlling the operation of both said external storing means and said buffering means, so let said multi-media data be transmitted into both said external storing means and said buffering means while said external storing means being available to store recently transmitted said multi-media data, and to let said multi-Omedai data only be transmitted into said buffering means while said external storing means being unavailable to store recently transmitted said multi-media data.

10. The digital multi-media input device of claim 9, said digital multi-media input device being a digital camera.

11. The digital multi-media input device of claim 9, said multi-media detecting means being chosen from the group consisting of charger coupled device and optical lens.

12. The digital multi-media input device of claim 9, said multi-media processing means being chosen from the group consisting of micro processor and application specific integrated circuits.

13. The digital multi-media input device of claim 9, said external storing means being chosen from the group consisting of CompactFlash, SmartMedia, MultiMedia Card, Secure Digital, and MemoryStick.

14. The digital multi-media input device of claim 9, said buffering means being chosen from the group consisting of flash and dynamic random access memory.

15. The digital multi-media input device of claim 9, possible reasons which let said external storing means be unavailable to storage any said multi-media data comprising the quota of said external storing means is full, said external storing means being exchanged, and said external storing means is failed.

16. The digital multi-media input device of claim 9, the operating steps of said storage controlling means comprising:
continuously storing partial said multi-media data which transmitted from said multi-media means only into said external storing means while said external storing means being available to store any recently inputted said multi-media data;
continuously storing partial said multi-media data which transmitted from said multi-media means only into said buffering means while said external storing means being unavailable to store any recently inputted said multi-media data; and
continuously storing partial said multi-media data which transmitted from said multi-media means only into said external storing means while said external storing means being available again to store any recently inputted said multi-media data, besides, all said multi-media data which are stored in said buffering means also are totally transmitted into said external storing means.

17. The digital multi-media input device of claim 9, comprising:
continuously storing partial said multi-media data which transmitted from said multi-media means into both said external storing means and said buffering means while said external storing means being available to store any recently inputted said multi-media data;
continuously storing partial said multi-media data which transmitted from said multi-media means only into said buffering means while said external storing means being unavailable to store any recently inputted said multi-media data; and
continuously storing partial said multi-media data which transmitted from said multi-media means into both said external storing means and said buffering means while said external storing means being available again to store any recently inputted said multi-media data, besides, all said multi-media data which are stored in said buffering means during the period that said external storing means being unavailable to store any recently inputted said multi-media data also are totally transmitted into said external storing means.

18. The digital multi-media input device of claim 17, the operating steps of said storage controlling means let partial said multi-media data which transmitted from said multi-media means be synchronously stored into both said external storing means and said buffering means while said external storing means being available to store any recently inputted said multi-media data.

19. The digital multi-media device of claim 18, the operating steps of said storage controlling means let partial said multi-media data which are stored in said buffering means be removed to let recently transmitted partial said multi-media data from said multi-media processing means can be stored in said buffering means in accordance with the step of first-in and first-out after the quota of partial said multi-media data which are stored in said buffering means exceeding a predetermined quota.

20. The digital multi-media device of claim 17, the operating steps of said storage controlling means let said multi-media data which are transmitted from said multi-media processing means be directly transmitted into said buffering means and indirectly transmitted into said buffering means in sequence while said external storing means being available to store said multi-media data, wherein any said multi-media data which are stored in said buffering means and exceeds a predetermined quota are removed into said external storing means, in accordance with the step of first-in and first-out, to let recently transmitted partial said multi-media data from said multi-media processing means can be stored in said buffering means.
